(19) United States
(12) Patent Application Publication
(10) Pub. No.: US 2004/0262318 A1
(43) Pub. Date: Dec. 30, 2004

(54) Container, method and system for cryptopreserved material

(75) Inventors: Stephen A. Buia, Hampton, NH (US); Alan J. Buckler, Arlington, MA (US); Mabel P. Buckler, Arlington, MA (US); Martin Lee Ferguson, Arlington, MA (US); Eileen Ann Lonergan, Sanford, ME (US); Stephen V. Chasse, Franklin, MA (US)

Correspondence Address: BOZICEVIC, FIELD & FRANCIS LLP, 1900 UNIVERSITY AVE, SUITE 200, EAST PALO ALTO, CA, 94303, US

(73) Assignee: Ardais Corporation

(21) Appl. No.: 10/870,486

(22) Filed: Jun. 16, 2004

Related U.S. Application Data
(63) Continuation-in-part of application No. 10/021,513, filed on Dec. 7, 2001.
(60) Provisional application No. 60/254,239, filed on Dec. 8, 2000.

(51) Int. Cl. A47J 41/00

(52) U.S. Cl. 220/592.01

(57) ABSTRACT

Containers that are suitable for long-term and efficient storage, tracking, and manual or robotic manipulation of cryopreserved biological materials, in particular human tissue samples, are disclosed herein along with systems comprised of multiple containers and methods of using such. According to one exemplary embodiment disclosed herein, a container may include a receptacle and a plurality of projections. The receptacle may include a lower wall and a side wall. The side wall may have an inner surface. The plurality of projections may extend upward along and outward from the inner surface of the side wall. The plurality of projections may define a region for receiving a sample having an orientation and may be shaped and arranged to inhibit a change in the orientation of the sample when stored in the container.

### CROSS-REFERENCE

This application is a continuation-in-part U.S. application of Ser. No. 10/021,513, filed Dec. 7, 2001, which claims the benefit of U.S. Provisional Application No. 60/254,239, filed Dec. 8, 2000 both of which are incorporated herein by reference in their entirety and to which application we claim priority under 35 USC § 120.

### FIELD OF THE INVENTION

This invention relates to specialized containers for cryopreservation of tissue samples and to systems and methods of using such.

### BACKGROUND OF THE INVENTION

Cryopreservation or freezing at very low temperatures has been an effective method for long-term preservation of biological materials. The goal of cryopreservation is to preserve the structural integrity and viability of biological materials for an indefinite period of time.

Cryopreservation typically involves enclosing biological material within a freezing medium to be frozen and preserved in a container often referred to as an ampoule or a tube. Because of their shape, these ampoules or tubes may be difficult to stack, thereby impeding efficient storage and retrieval of the biological materials contained therein. As a result, standard storage vials are often stored in freezers using ordinary plastic bags or cardboard boxes. These conventional approaches to storage have proven to be inadequate for maintaining and tracking a large inventory of specimens.

Further, cataloging specimens in these standard storage vials is often difficult and time consuming. Usually, labeling of the specimens consists of writing notes on the side of an ampoule or tube by hand. Upon freezing and thawing several times, the writing can become illegible. Consequently, frozen specimens are sometimes misused, misplaced, misidentified or even lost.

Accordingly, there remains a need in the art for a cryopreservation container and method of using such which is suitable for efficient long-term storage, tracking, and retrieval of biological materials, and that also overcomes the current difficulties associated with standard storage vials and methods.

### SUMMARY OF THE INVENTION

A container, a system comprised of a plurality of containers and a method for the storage of frozen tissue is described. The container is disclosed in a variety of embodiments each of which are preferably comprised of a bottom portion which is comprised of both a bottom plate and an upwardly extending cylindrical wall. The cylindrical wall preferably includes threadings at its upper end which threadings match to threadings on a top portion of the container. Because the bottom and top portions of the container are threaded together and undergo substantial changes in temperature including extremely low temperatures the top and bottom portions should be comprised of different polymeric materials and should be cleaned of any debris or moisture prior to screwing the top onto the bottom portion to prevent the two parts from sticking together while allowing an air tight seal between the top and the cylindrical side walls. The different materials may be, for example, different polymeric materials such as polyethylene and polypropylene and/or various mixtures thereof which are polymerized in a manner as so to obtain substantially rigid components which can be readily molded such as by injection molding into the container component shapes desired.

The materials can be tested by those of skill in the art in order to determine relative coefficients of expansion at different temperatures used so that the top and bottom portions can be connected and disconnected by screwing the two components together at a wide range of different temperatures. Further, the coefficients of expansion and contraction at different temperatures should be such that the top and bottom portions remain sealed to each other without sticking but not allowing the outside atmosphere to penetrate into the interior of the container or allow gases within the interior of the container to escape into the outside atmosphere.

A system of the invention is comprised of a plurality of containers. A bottom surface of the bottom component or base of the container is designed (e.g., 3-D shape) so as to receive and interlock with the top surface of the top portion of another container. In this manner the containers can be stacked on top of each other and, to a degree, interlocked with each other by having 3-D shapes which fit into each other. However, the composition of the polymeric materials contacting each other needs to be considered so as to prevent the containers from sticking together while still allowing them to be interlocked stably.

In a method of the invention, a desired tissue sample or a plurality of tissue samples are placed within the container and one or more surfaces on the container are designed so as to act as a label or to receive and hold a label which label may be in the form of various indicia, letters, numbers, bar codes, transistors, microchips, quantum dots or other labeling components which might be used to identify one or a plurality of different tissue samples contained within the container.

The system is preferably designed such that the label can be read electronically. After the information is understood by a microprocessor device information relating to the tissue samples in the device is displayed on a user screen. Thus, for example, by stacking a plurality of containers on top of each other due to interlocking components on the tops and bottoms of the consecutive containers with the label facing outward the label on a plurality of containers can be readily determined such as with a bar code reader and the contents of one, all or any of the containers displayed on a screen. The contents can be described on a label to include information such as the type of tissue, the individual the tissue was obtained from, treatment protocols that were used on the individual, treatment outcome, medical diagnosis that was provided to the tissue, histological comments relating to a closer examination of the tissue, type of cells, type of organ, and the age, sex and race of the donor, etc.

It is possible for each container to include a single tissue sample. However, a container of the invention may be designed to include a plurality of tissue samples such as 2, 3, 4, 5 or more, 10 or more, 20 or more, 50 or more or 100 or more different samples. Further, the label provided on the container may be designed so as to provide information with respect to each of the different tissue samples within the container indicating the specific location or coordinates such as the projection within the container that the particular tissue sample is associated with such as being present on or present between one or more projections inside the container. To facilitate such the projections may also be labeled or numbered in an appropriate manner (e.g. column and row number or letter) so as to make it possible to readily associate a particular tissue sample within the container with its description.

One aspect of the invention is a container for storing a sample such as a tissue sample of a mammal such as a human, a plant or cellular sample. The container may be comprised of a base having an inner upwardly facing surface and an outer downwardly facing surface. A receptacle wall such as a cylindrical receptacle wall that may extend upward from the base such as upward from the upwardly facing surface of the base and the wall may have threadings on its upper end either inside or outside of the container. The container is further comprised of a cover portion which includes and a downwardly facing surface. The top is preferably circular and comprises threadings on its outer surface which match the threadings on the top of the receptacle walls. In addition the top preferably includes indentations which can be readily gripped by a human or by a robotic device to make it possible to easily remove the top. Further, the device includes marking panel which extends outwardly from and may be an integral part of the component of the container. A flat planar surface upon which an indicia can be described or it may be a surface which can have inserted therein a label such that the label is securely held in place. The container preferably includes a plurality of projections which extend into the inner portion of the receptacle which projections have a top surface facing upward and a bottom surface facing downward and are connected to either the top surface of the base or the inner surface of the receptacle walls. The projections are preferably shaped and arranged in a manner so as to inhibit a change in the orientation and position of a human tissue sample which is positioned in the container when the container is moved. Further, the projections in the container may have removably attachable identification panels or labels positioned thereon which labels include indicia which specifically identify each tissue sample in the container.

Containers that are suitable for long-term and efficient storage, tracking, and manual or robotic manipulation of cryopreserved biological materials, in particular human tissue samples, are disclosed herein. The containers disclosed herein can be used as a part of an automated inventory management system for frozen tissue samples.

According to one exemplary embodiment disclosed herein, a container may include a receptacle and a plurality of projections. The receptacle may include a lower wall and a side wall. The side wall may have an inner surface. The plurality of projections may extend upward along and outward from the inner surface of the side wall. The plurality of projections may define a region for receiving a sample having an orientation and may be shaped and arranged to inhibit a change in the orientation of the sample when stored in the container.

According to another exemplary embodiment disclosed herein, a container may include a base, a receptacle, a cover, a marking panel, and a plurality of projections. The base may have a top surface and a first end. The receptacle may extend upward from the top surface of the base and have an inner surface and a cross-section that has a substantially circular shape. The cover may threadably engage the receptacle and form a fluid-tight seal with the receptacle for confining a sample within the receptacle and inhibiting desiccation of the sample. The marking panel may extend from the first end of the base and may have a substantially planar surface for receiving identifying indicia. The plurality of projections may extend upward along and outward from the inner surface of the receptacle and upward from the top surface of the base. A projection may have at least a first side, a second side, and a third side, in which the first side faces the inner surface of the receptacle, the second and third sides are substantially planar, and the second side is oriented in a direction perpendicular to the third side. The plurality of projections may be shaped and arranged to inhibit a change in the orientation of a sample when stored in the container.

According to another exemplary embodiment disclosed herein, a base may have a bottom surface. The bottom surface may have a particular 3-dimensional configuration such as a plurality of protrusions projecting downward therefrom. The protrusions may be shaped and arranged to permit an identification panel containing identifying indicia to be removably and securely attached to the container.

These and other objects, advantages, and features of the invention will become apparent to those persons skilled in the art upon reading the details of the various embodiments as more fully described below.

### BRIEF DESCRIPTION OF THE DRAWINGS

These and other features of the containers disclosed herein will be more fully understood by reference to the following detailed description in conjunction with the attached drawings in which like reference numerals refer to like elements throughout the different views. While the drawings illustrate principles of the containers disclosed herein, they are not drawn to scale, but show only relative dimensions.

FIG. 1A is a top perspective view of an embodiment of the cryopreservation container disclosed herein.

FIG. 1B is a bottom perspective view of the cryopreservation container in FIG. 1A.

FIG. 2A is a top view of a cover.

FIG. 2B is a view of the underside of the cover in FIG. 2A.

FIG. 2C is a sectional view of the cover of FIG. 2A along line C-C, showing internal threads.

FIG. 3A is top view of the cryopreservation container of FIG. 1A.

FIG. 3B is a sectional view of the bottom of the cryopreservation container of FIG. 1A.

FIG. 3C is a sectional view of the cryopreservation container of FIG. 3A along line C-C, showing external threads.

FIG. 4 is a sectional view of the cryopreservation container of FIG. 3A along line A-A, illustrating a cover attached to the receptacle.

FIG. 5 is a sectional view of the cryopreservation container of FIG. 1A, showing a flat marking surface.

FIG. 6 is a top view of a receptacle, showing an alternative configuration of projections.

FIG. 7A is a top perspective view of another embodiment of the cryopreservation container disclosed herein.

FIG. 7B is a bottom perspective view of the cryopreservation container in FIG. 7A.

### DETAILED DESCRIPTION OF THE INVENTION

Before the present device, method and system are described, it is to be understood that this invention is not limited to particular embodiments described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It must be noted that as used herein and in the appended claims, the singular forms “a”, “an”, and “the” include plural referents unless the context clearly dictates otherwise. Thus, for example, reference to “a container” includes a plurality of such containers and reference to “the indicia” includes reference to one or more indicia and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Certain exemplary embodiments will now be described to provide an overall understanding of the principles of the containers disclosed herein. One or more examples of these embodiments are illustrated in the drawings. Those of ordinary skill in the art will understand that the containers described herein can be adapted and modified to provide instruments and methods for other suitable applications and that other additions and modifications can be made without departing from the scope of the containers disclosed herein. For example, the features illustrated or described as part of one embodiment or one drawing can be used on another embodiment or another drawing to yield yet another embodiment. Such modifications and variations are intended to be included within the scope of the present disclosure.

### INVENTION IN GENERAL

The tissue storage container of the invention may have a variety of different configurations. Each container may be comprised of a base plate or bottom component, walls extending upward from the base plate and preferably integral with the base plate and a cover or top component which can be readily connected and disconnected from the wall component so as to form a container. The container is preferably comprised of a co-polymer which can be frozen, thawed, and refrozen multiple times with a sample such as a tissue sample present therein without destroying the structural integrity of the container. It is preferable that the outwardly facing bottom surface of the base plate have a particular configuration so as to match with the outwardly facing top surface of the cover. This makes it possible to stack one container on top of another in a manner which provides for structural integrity of the stack of containers. Each container preferably includes a label which preferably can be read electronically making it possible to readily identify the contents of the container.

In accordance with one embodiment the tissue storage container comprises:

a base plate comprised of a first polymeric material and comprising an upper surface and an opposite lower and outwardly facing surface wherein the lower surface is non-planar with a distinct 3-dimensional configuration;

a substantial cylindrical wall connected to (integral with) and extending from the upper surface of the base plate to an upper end with threadings positioned on the outer or inner surface of the wall, the wall comprised of the first polymeric material;

a cover comprised of a second polymeric material different from the first polymeric material, the cover comprising a circular portion having threadings thereon which match and screw to the threadings on the wall and the cover comprising an upper surface which is non-planar and comprise a configuration which fits to (e.g., a mirror image of) the lower surface of the base plate;

a tissue sample positioned in the container;

wherein the first polymeric material and second polymeric material comprise physical characteristics allowing the container to be frozen and thawed repeatedly without lose of structural integrity and while maintaining a substantially air tight seal while the cover is in place on the threadings of the wall.

The system of the invention essentially comprises two, three or a plurality of containers stacked on top of each other. More specifically, the lower surface of the base plate of one container fits into the distinct configuration on the upper surface of the cover of another container allowing the containers to be stacked. By having the non-planar distinct configurations on the surfaces the containers can be readily stacked and held in place.

The system of the invention comprises a plurality of stacked containers wherein each of the containers further comprises one or more labels which may be in the form of a marking panel extending from a first end of the base, the marking panel having a substantially smooth surface for receiving identifying indicia. A tissue sample is placed in the container and frozen. By using the indicia on the marking panel it is possible to identify the tissue in the container and associate that tissue with particular characteristics in research. In one embodiment the indicia is in the form of a bar code and a plurality of containers are stacked with a bar code present on the marking panel of each container. By moving a bar code reader across the bar code on each container the use can readily determine the contents of each of the containers and information such as the tissue type, characteristics of the subject such as the human patient from which the tissue was obtained, treatment protocols, outcomes of those protocols and the like.

An aspect of the invention is that the container includes a label or plurality of labels and/or a plurality of containers are marked with a single label. The label may include a wide range of different information such as the type of tissue, the individual the tissue was obtained from, the treatment, or group of treatment protocols which were used on the individual, treatment outcomes, medical diagnosis that was provided on the individual and/or with respect to the tissue sample, histological comments relating to a closer examination of the tissue, cell types, organ type, as well as the age, sex, race and/or other information of the donor of the tissue sample provided inside of the container.

Although different types of labels can be used it is preferable that a single type of label be used on all of the containers within a given system. Thus, all of the containers could, for example, include a bar code label or all of the container could include a transistor. Bar codes are particularly useful in that they can be readily generated and read by bar code readers. The transistors are useful in that they can be very specifically individualized at a very low cost and embedded into a portion of the polymeric container and connected to an electrical component so that they can be readily read and understood by a computer system.

In accordance with the method of the invention a plurality of tissue samples are included within a plurality of different containers which containers are stacked or interconnected together so as to provide a system. The user reads the labels such as by waving a bar code reader over bar codes present on the labels. The information present on the labels is generated on the user's computer screen. The user can then identify tissue samples which are of interest in particular containers. Having identified the tissue sample of interest the container can be removed, the sample removed from the container and examined or subjected to testing or further examination and/or analysis. That analysis may include a comparison to another tissue sample in order to determine the likelihood of success with a particular treatment protocol and the results of the analysis may be added to the label.

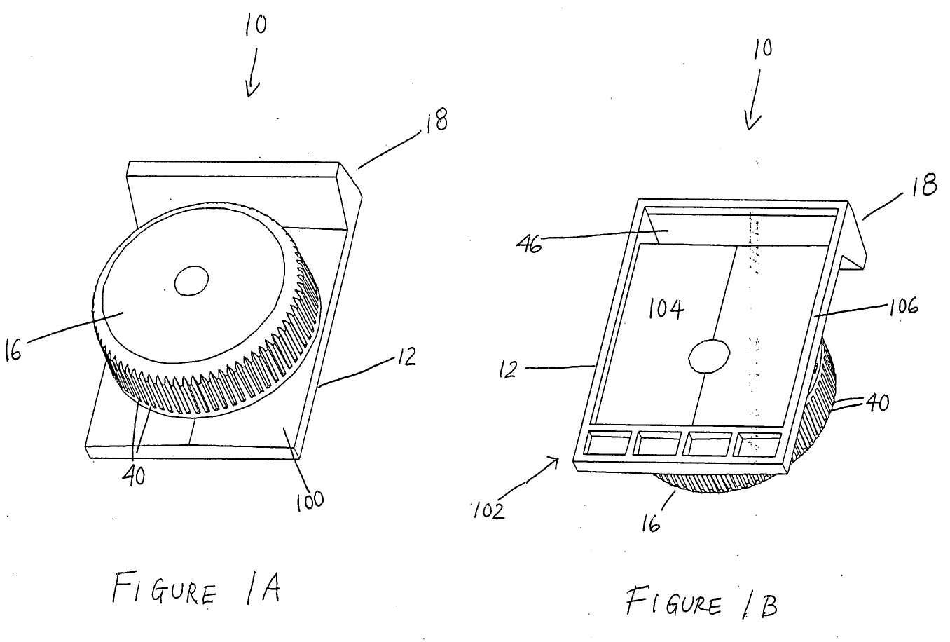

An exemplary embodiment of a container for storing cryopreserved material is illustrated in FIGS. 1-7. As shown in FIGS. 1-7, the container 10 includes a base 12, a receptacle 14, a cover 16, and a marking panel 18.

As shown in FIGS. 1A and 1B, the base 12 has a substantially rectangular shape. The base 12 may, however, have a variety of shapes. For example, the base 12 may have the shape of any type of polygon, including a square, a rectangle, and a triangle, or the shape of any type of oval, including an ellipse and a circle.

As shown in FIGS. 1A and 1B, the base 12 has a substantially planar top surface 100 and a bottom surface 102 that has a recessed interior portion 104 and a raised exterior portion 106. The top and bottom surfaces 100, 102 of the base may have a variety of other constructions, as provided below.

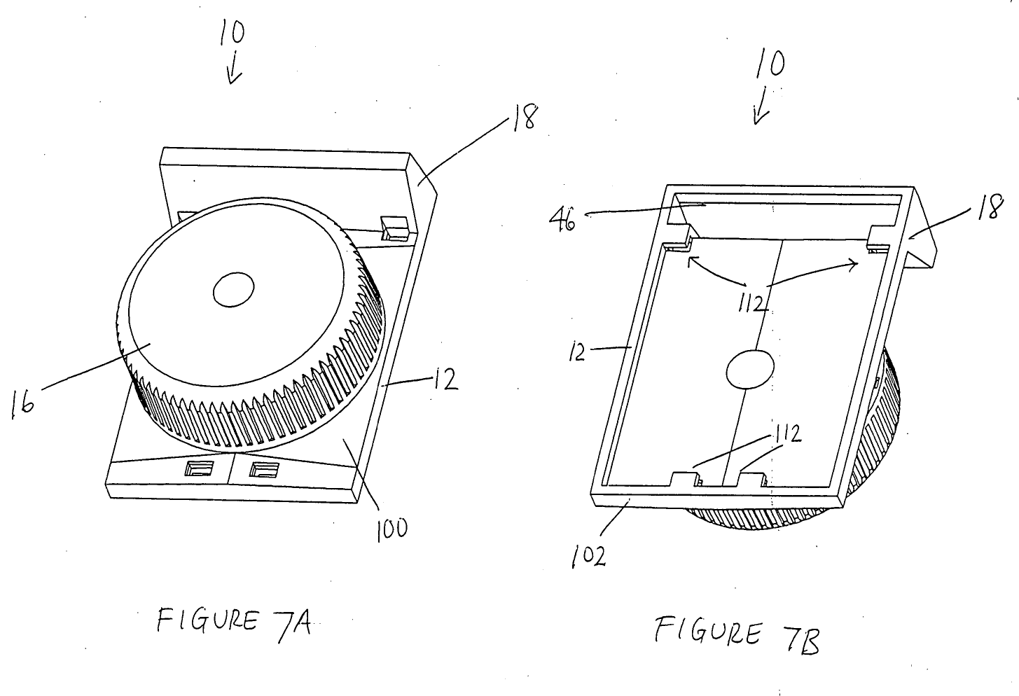

An alternative construction of the base 12 is illustrated in FIGS. 7A and 7B. As shown in FIGS. 7A and 7B, the bottom surface 102 of the base 12 may include protrusions 112 shaped and arranged to permit an identification panel containing indicia identifying the contents of the container 10 to be securely and removably attached to the container 10. The identification panel may be any structure known to one of ordinary skill in the art for containing indicia, including, but not limited to, impressions or protrusions in any type of surface, such as writing on paper, embossing on plastic, or a bar code designed to be read by an optical scanner.

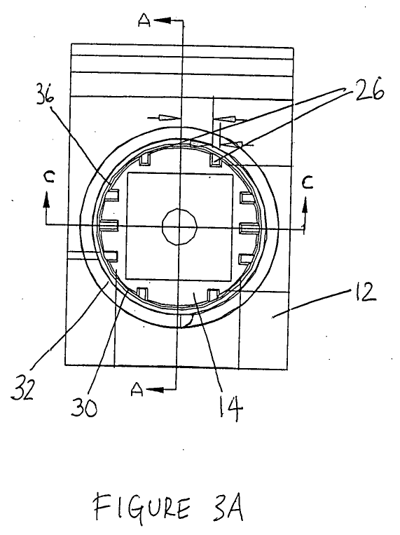

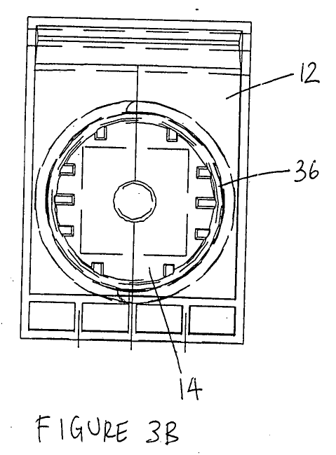

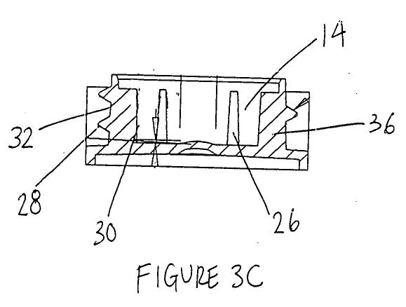

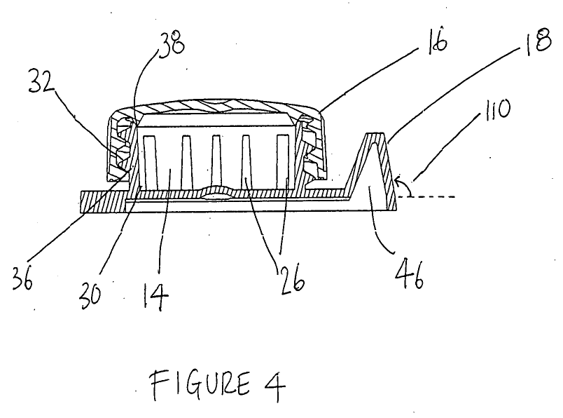

As shown in FIGS. 3A, 3B, and 3C, the container 10 includes a receptacle 14. The receptacle 14 may be formed integral with the base 12, or the receptacle may be formed separately and attached to the base using any securing means known to one of ordinary skill in the art, including, but not limited to, an adhesive and a weld. Apart from being permanently attached to the container 10, the receptacle 14 may be removably and replaceably attached to the container 10.

As shown in FIGS. 3A, 3B, and 3C, the receptacle 14 is defined by a wall 36 that extends upward from the top surface 100 of the base 12. The wall 36 may extend in a direction substantially perpendicular to the base 12, and the receptacle 14 may have a cross-section that is substantially circular and consistent in diameter throughout the upward extent of the wall 36. The receptacle 14 may, however, have a variety of other constructions. The receptacle 14 may have the shape of a cylinder, a cone, a bowl, or a box. The receptacle 14 may have a cross-section that has the shape of any type of polygon, including a square, a rectangle, and a triangle, or any type of oval, including a circle and an ellipse. Moreover, the receptacle 14 may have a cross-section that has a first extent that varies over the upward extent of the wall 36. For example, the receptacle 14 may have a circular cross-section characterized by a diameter that varies over the upward extent of the wall 14. Additionally, the receptacle 14 may have a cross-section whose basic shape varies over the upward extent of the wall. For example, the receptacle 14 may have a square cross-section for a first portion of its height and a circular cross-section for a second portion of its height.

In alternative embodiments, the container 10 may be constructed without a base 12. In these embodiments, and other embodiments in which the receptacle 14 is separate or removable from the base 12, the receptacle 14 is defined by a lower wall and a side wall. In those embodiments in which the receptacle 14 is attached to the base 12, the top surface 100 of the base 12 provides the lower wall of the receptacle 14.

As shown in FIGS. 3A, 3B, and 3C, projections 26 are enclosed within the wall 36 of the receptacle 14. The projections 26 are shaped and arrange to inhibit a change in the orientation and position of a sample within the container 10. The wall 36 has an inner surface 30 and an outer surface 32. As shown in FIGS. 3A, 3B, and 3C, the projections 26 may extend upward from the top surface 100 of the base 12 along the inner surface 30 of the wall 36. The projections 26 may also have a variety of other positions. For example, the projections 26 may not be contiguous with the base 12, but may simply project upward along and outward from the inner surface 30 of the wall 36. Alternately, the projections 26 may not be contiguous with the wall 36, but may simply project upward from the top surface 100 of the base 12. The projections 26 may be formed integral with the base 12, the wall 36, or both the base 12 and the wall 36. Alternately, the projections 26 may be formed separately and attached to the base 12, the wall 36, or both the base 12 and the wall 36 using any means known to one of ordinary skill in the art, including, but not limited to, an adhesive or a weld. Apart from being permanently attached to the container 10, the projections 26 may be removably and replaceably attached to the container 10.

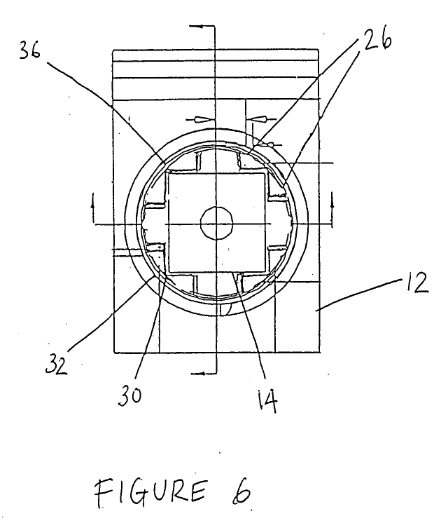

As shown in FIGS. 3A, 3B, 3C and 6, the projections 26 decrease the space within the receptacle 14, thereby defining a region for receiving a sample. The projections 26 are shaped and arranged within the receptacle 14 to inhibit a sample from rotating from a desired orientation and moving from a desired position. The projections 26 may have a variety of shapes and arrangements in addition to those shown in FIGS. 3A, 3B, 3C, and 6. For example, the projections 26 may have cross-sections that are hemispherical. Additionally, the projections 26 may extend along the entire upward extent of the wall 36, or the projections 26 may extend along only a portion of the upward extent of the wall 36 in order to accommodate samples having different shapes. For example, in one embodiment, as shown in FIG. 3C, the projections 26 may extend only partway along the upward extent of the wall 36 in order to accommodate samples that have mushroom-like shapes.

As shown in FIGS. 1A and 1B, the container 10 includes a cover 16 removably attached to the container 10 for confining the sample within the container 10.

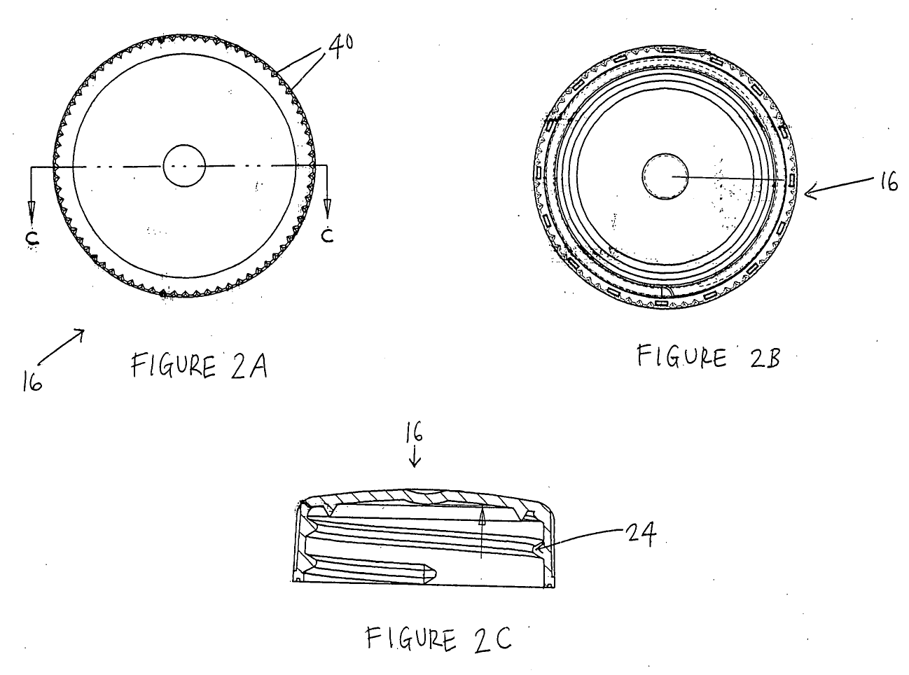

As shown in FIG. 2C, the cover 16 may threadably engage the container 10. The cover 16 may have internal threads 24 that engage external threads 28 formed on the outer surface 32 of the wall 36 of the receptacle 14. Rotation of the cover 16 relative to the base 12 and the receptacle 14 may be used for opening and closing the container 10. Rotation may occur in either the clockwise or counter-clockwise direction. Preferably, rotation in one direction is used to open the container 10, and rotation in the opposite direction is used to close the container 10. Preferably, the rotation is not greater than 360 degrees in either direction to open or close the container, and most preferably the rotation is 270 degrees.

Additionally, the cover 16 may engage the receptacle 14 to provide a fluid-tight seal, thereby inhibiting desiccation of the contents. Also, the cover may engage the receptacle so as to provide a seal that withstands at least approximately 80 kPa of internal pressure, and preferably at least approximately 95 kPa of internal pressure.

The cover 16 may be removably attached to the receptacle 14 by using any structure known to one of ordinary skill in the art, including, but not limited to, a press-fit or a snap-on mechanism.

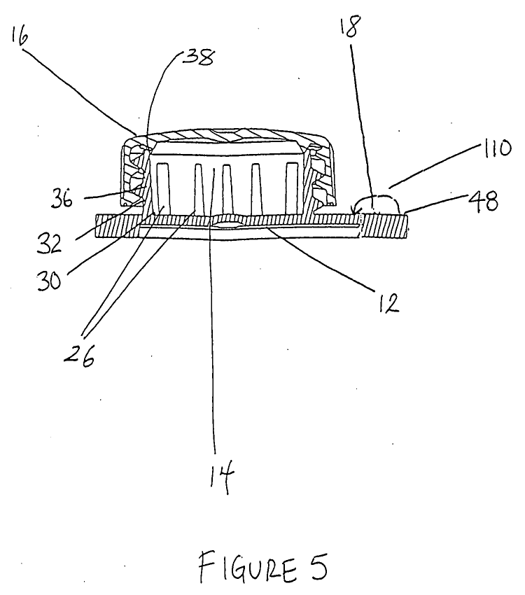

The cover 16 may also have a variety of shapes, provided that it is mated to the receptacle 14 to confine the sample within the container 10. The cover 16 may be shaped so as to have a portion that fits around the outer surface of the wall 36, or the cover may be shaped so as to have a portion that fits inside the wall 36. For example, as shown in FIG. 4, the cover 16 may have a lip 38 that engages the inner surface 30 of the wall 36 of the receptacle portion 14 in a substantially fluid-tight seal to inhibit degradation of a sample in the container 10. As shown in FIGS. 1A and 1B, the outer surface of the cover 16 may contain serrations 40 to facilitate gripping or robotic manipulation.

As shown in FIGS. 4 and 5, the container 10 includes a marking panel 18 for receiving indicia identifying the contents of the container 10. The marking panel 18 may be formed integrally with the base 12, or may be formed separately and attached to the base using any means known to one of ordinary skill in the art, including, but not limited to, an adhesive and a weld. Apart from being permanently attached to the container 10, the marking panel 18 may be removably and replaceably attached to the container 10. The marking panel 18 may include a substantially smooth and substantially planar surface to facilitate observation of identifying indicia positioned thereon. As shown in FIG. 4, in one embodiment, the marking panel 18 may form an angle 110 with the top surface 100 of the base 12, and may be formed by a recess 46 in the underside of the base 12. Alternative constructions of the marking panel 18 and alternative angles 110 are possible. For example, the marking panel may form any angle 110 with the top surface 100 that is greater than 90 degrees. Additionally, as shown in FIG. 5, in another embodiment, the marking panel 18 may be flat 48, that is, may form an angle 110 of 180 degrees with the top surface 100 of the base 12, and may be formed by extending one side of the base 12.

Although the containers of the invention may have a variety of different sizes, shapes and configurations those shown within the figures are particularly useful. The container may have a total liquid volume in a range of from about 0.1 cubic inches to 5 cubic inches or 0.2 cubic inches to 2 cubic inches or more particularly about 0.228 cubic inches. However, containers of the invention are not likely to utilize the total volume in terms of liquid volume of the container but rather to utilize a portion of the container volume for a solid tissue sample to be placed therein. The solid tissue sample which could be held in a useful container might be in the range of 0.05 cubic inches to about 5 cubic inches or 0.1 cubic inches to 1 cubic inch or more particularly about 0.13 cubic inches.

A container which is somewhat cylindrical in shape such as that show within the figures may have an outside diameter in a range of about 0.25 inches to 5 inches, or 0.5 inches to 2 inches or more particularly about 0.88 inches. The container wall thickness might be in the range of about 0.05 inches to about 0.5 inches or more particularly about 0.12 inches.

As shown within the figures the outside diameter may vary due to ungulations in the outer circumference surface making it possible for a human or a robot to readily grip the top portion of the container so that it can be turned and unscrewed from the upwardly extending walls of the container.

As indicated above a range of different types of materials can be used in forming the containers of the invention. It is preferable to utilize polymeric materials which can be formed by injection molding. It is also preferably for the polymeric material making up the container base and walls to be the same whereas the polymeric material making up the cover or top portion to be a different polymer so that when the two components expand and contract they do so while maintaining the same relative distance to each other thereby not breaking the container walls or the container cap and allowing for removal of the cap portion.

One polymeric material which may be used in connection with the invention is a high density polyethylene copolymer which is sold by Chevron Phillips Chemical Company under the tradename Marlex® HiD®9035. Basic information relating to this material is provided below.

Product Characteristics

| | | |
|---|---|---|
| Material Status | Commercial: Active | |
| Availability | North America | Pacific Rim |
| | South America | Europe |
| Test Standards | ASTM | |
| Available | | |
| Features | Copolymer | Impact Resistance, Good |
| | Flow, Good | ESCR, High (Stress |
| | | Crack Resist. |
| Uses | Toys | |
| | Containers, Thin-Walled | |
| Agency Ratings | ASTM D 4978-A52600 | |
| | ASTM D 4976-PE231 | |
| Forms | Pellets | |
| Processing Method | Injection Molding | |

Properties¹

| | Nominal Values (English) | Test Method |
|---|---|---|
| Physical | | |
| Density | 0.952 g/cm | ASTM D1505 |
| Melt Mass-Flow Rate | 40.0 g/10 min | ASTM D1238 |
| (MFR) (190° C./2 16 kg) | | |
| Apparent Density | 0.591 sp gr 23/23° C. | ASTM D1895 |
| Mechanical | | |
| Tensile Strength @ Yield² | 3400 psi | ASTM D638 |
| Tensile Elongation Brk² | 100% | ASTM D638 |
| Flexural Modulus | ASTM D790 | |
| (Method 1 (1point load)) | Secant: 140000 psi | |
| (Method 1 (3 point load)) | Tangent: 180000 psi | |
| Thermal | | |
| Vicat Softening Point | 243° F. | ASTM D1525 |

Additional Properties

The value listed as Density, ASTM D1505, was tested in
accordance with ASTM D4883, Melt Flow Ratio, ASTM D1238,
(190° C./21. Bkg)/(190° C./2, 16 kg): 27
Elongation @Break, ASTM D638: <100%
¹Typical properties: not to be construed as specification.
²Type IV, 2 in/min

In another polymer which can be used for producing a container component in connection with the present invention is a polypropylene copolymer sold by BP Amoco Polymers, Inc. sold under the tradename ACCTUF® 3243. this copolymer has the following characteristics.

Product Characteristics

| | |
|---|---|
| Material Status | Commercial: Active |
| Availability | North America |
| | Europe |
| Test Standards Available | ASTM |
| Additive | Impact Modifier |
| Features | Copolymer |
| | General Purpose |
| | Impact Resistance, Ultra High |
| Agency Ratings | FDA 21 CFR 177 1520¹ |
| Forms | Pellets |
| Processing Method | Injection Molding |

Properties²

| | Nominal Values (English) | Test Method |
|---|---|---|
| Physical | | |
| Density | 0.905 g/cm³ | ASTM D1505 |
| Melt Mass-Flow Rate | 5.00 g/10 min | ASTM D1238 |
| (MFR) (230° C./2 16 kg) | | |
| Mold Shrink Linear-Flow | 0.010 to 0.025 in/in | ASTM D955 |
| Water Absorption @ 24 hrs | 0.010% | ASTM D570 |
| (73° F.) | | |
| Mechanical | | |
| Tensile Strength @ Yield | 3800 psi | ASTM D638 |
| (73° F.) | | |
| Tensile Elongation Brk | 500% | ASTM D638 |
| (73° F.) | | |
| Flexural Modulus (73° F.) | 180000 psi | ASTM D790 |
| Impact | | |
| Notched Izod Impact | | ASTM D256 |
| (−4° F., 0.125 in) | 1.0 ft-lb/in | |
| (73° F., 0.125 inc) | No Break ft-lb/in | |
| Gardner Impact (−4° F.) | 125 in/lb | ASTM D3028 |
| Hardness | | |
| Rockwell Hardness (R- | 77 | ASTM D785 |
| Scale) | | |
| Thermal | | |
| DTUL @56 psi - | 210° F. | ASTM D648 |
| Unannealed | | |

Additional Properties

Density, ASTM D1505: 0.904 to 0.908 g/cm³
Water Absorption, ASTM D570, 24 hr. 23° C.: <0.01%
Tensile Elongation @Break, ASTM D638, 23° C. : >500%

In general, a container of the invention is produced by injection molding of a heated polypropylene copolymer which can be purchased in pellet form. The copolymer is of a type which is referred to as high impact modified copolymer which is impact resistant and sold in pellet form. The hardened copolymer has a density of about 0.9 g/cm³ and very low water absorption of about 0.01% or less over 24 hours at about 73° F. The tensile strength should be relatively high and should have a Rockwell hardness on the R-scale of about 77. Those skilled in the art will recognize that variations in these parameters of ±20% or ±10% or ±5% may be used in connection with the present invention.

The base 12, receptacle 14, and cover 16 are constructed from polymeric material. The cover 16 may be constructed from a different polymeric material than the receptacle 14 to inhibit the binding of the receptacle 14 and the cover 16 at low temperatures. For example, the cover 16 may be made of polyethylene, and the receptacle 14 may be made of polypropylene. The container 10 may also be fabricated from any other material suitable for cryopreservation, including, but not limited to, glass, stainless steel, and any other inert metal.

The base 12, receptacle 14, and cover 16 may be constructed to be transparent to facilitate observation and identification of a sample within the container 10. Alternately, the base 12, receptacle 14, and cover 16 may be constructed to be opaque to prevent light from degrading a sample within the container 10 during storage.

The receptacle 14 and the cover 16 may be coated with one or more layers of one or more biologically inert materials to facilitate cryopreservation in various chemical environments. The receptacle and the cover may also be coated with one or more layers of one or more biologically inert materials to enhance resistance to corrosion by substances used in cryopreservation.

The containers disclosed herein are compatible with a variety of biological samples. Suitable biological samples for the containers disclosed herein include, but are not limited to, samples derived from human tissue, animal tissue, and plant tissue by any means known to one of ordinary skill in the art.

### APPLYING COMPUTER SYSTEMS

The label may use one or more of the various technologies developed for studying genetic mutations, aberrant gene expression patterns and faulty protein interactions that cause or contribute to disease. A better understanding of the molecular basis of many diseases has resulted in the identification of gene and protein targets (markers) that have been useful for developing novel therapeutics and diagnostics.

Biological materials obtained from patients may be included in a container of the invention. The labeling may be used to show a correlation of patient samples with broad, structured clinical information about the patient to increase the value of these materials for research. (Skjei E, “Arraying the data,” CAP Today, March 2001, www.CAP.org/HTML/publications/archive, downloaded Aug. 16, 2001). In addition to the clinical information, the availability of pathological information that characterizes the material would allow a researcher to better define particular material that would be useful in a certain line of research.

Labeling of containers as described here would improve the availability of high quality biological materials associated with patient clinical information. The labeling aids in the effective correlation of the materials with the patient record.

The containers and systems of the invention may be combined with computer implemented methods for providing biological materials (such as tissues, cell or cell containing specimens) or derivative products (such as isolate cells, cell sections, tissue section, histocores or cellular components (e.g. DNA, RNA, protein, lipids, etc)) to a user. After obtaining information and including such on a label on the container of the invention the information may be used in a method comprising the steps of: receiving a user query, which identifies at least one desired characteristic of the biological material; identifying a biological material that has the at least one characteristic; receiving specification of the format for the biological material; and providing to the user, the at least one biological material or derivative product, in the specified format.

In another embodiment, after obtaining information and including such on a label on the container of the invention the information may be used in a method comprising the steps of: (a) receiving from a user a query, which identifies at least one desired characteristic of the biological material; (b) identifying biological material that has the at least one characteristic; and (c) providing to the user the clinical data associated with the biological material identified in step (b).

Use of the containers, labels and systems of the invention with the methods will enable researchers to identify and obtain appropriate patient samples for particular studies. In addition access to the patient sample correlated clinical information and sample-level-information can be useful for the performance of statistical studies or for making or confirming a diagnosis.

Further, the containers, labels and systems of the invention can be used with a computer implemented method for providing a biological material or a derivative product thereof to a user, the method comprising: receiving a query from a user, which identifies at least one desired characteristic of the biological material; identifying a biological material that has the at least one characteristic; receiving specification of the format for the biological material; and providing the at least one biological material or derivative product, in the specified format to the user. The characteristic may be clinical data and the clinical data may be any or all of: familial data, clinical history data, medication data, disease data, treatment history data, demographic data, laboratory report data, pathology report data, histology report data, and outcome report data.

The containers, labels and systems of the invention may be used with a method comprising: identifying a collection of more than one codes of a standard coding scheme, different codes corresponding to different concepts of the standard coding scheme; forming a pre-coordinated code from a concatenation of the more than one codes, the pre-coordinated code not being found in the standard coding scheme; and storing the pre-coordinated code along with other pre-coordinated codes. The method may include storing a collection of one or more lexical terms describing a concept associated with the pre-coordinated code. The codes comprise SNOMED (Systemized Nomenclature of Human and Veterinary Medicine) codes.

Concatenating the codes may comprise concatenating the codes in accordance with at least one syntax rule. The at least one syntax rule may be a rule specifying an ordering of terms according to their SNOMED axis. Further details relating to computer systems may be found in published U.S. Pat. Nos. 2003/0088363 published May 8, 2003 and 2003/0,154,105 published Aug. 14, 2003 both of which are incorporated herein in their entirety.

The preceding merely illustrates the principles of the invention. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

That which is claimed is:

1. A tissue storage container, comprising:
a base plate comprised of a first polymeric material and comprising an upper surface and an opposite lower surface wherein the lower surface is non-planar with a distinct configuration;
a substantial cylindrical wall connected to and extending from the upper surface of the base plate to an upper end with threadings positioned therein, the wall comprised of the first polymeric material;
a cover comprised of a second polymeric material different from the first polymeric material, the cover comprising a circular portion having threadings thereon which match and screw to the threadings on the wall and the cover comprising an upper surface which is non-planar and comprise a distant configuration which is a mirror image of the lower surface of the base plate;
a tissue sample positioned in the container;
wherein the first polymeric material and second polymeric material comprise physical characteristics allowing the container to be frozen and thawed repeatedly without lose of structural integrity and while maintaining a substantially air tight seal while the cover is in place on the threadings of the wall.

2. The container of claim 1, further comprising:
a plurality of projections extending upward along and outward from an inner surface of the wall, the projections defining regions for receiving a sample having an orientation, the projections being shaped and arranged to inhibit a change in the orientation of the sample when stored in the container.

3. The container of claim 2 wherein each of the projections has a cross-section having at least a first side, a second side, and a third side, the first side facing the inner surface of the receptacle, the second and third sides being substantially planar.

4. The container of claim 3 wherein the second side is oriented in a direction substantially perpendicular to the third side.

5. The container of claim 2 wherein each of the projections has a cross-section having a substantially hemispherical shape.

6. The container of claim 2 wherein the projections are formed integrally with the receptacle.

7. The container of claim 2 wherein the projections are removably and replaceably attached to the receptacle.

8. The container of claim 1, further comprising:
a marking panel extending from the first end of the base, the marking panel having a substantially smooth surface for receiving identifying indicia.

9. The container of claim 8 wherein the marking panel forms an angle with the top surface of the base, the angle being at least 90 degrees.

10. The container of claim 8 wherein the marking panel is formed integrally with the base.

11. A tissue storage system, comprising:
a first container; and
a second container;
wherein the first container and the second container are each comprised of:
a base plate comprised of a first polymeric material and comprising an upper surface and an opposite lower surface wherein the lower surface is non-planar with a distinct configuration;
a substantial cylindrical wall connected to and extending from the upper surface of the base plate to an upper end with threadings positioned therein, the wall comprised of the first polymeric material;
a cover comprised of a second polymeric material different from the first polymeric material, the cover comprising a circular portion having threadings thereon which match and screw to the threadings on the wall and the cover comprising an upper surface which is non-planar and comprise a distant configuration which is a mirror image of the lower surface of the base plate;
a tissue sample positioned in the container;
wherein the first polymeric material and second polymeric material comprise physical characteristics allowing the container to be frozen and thawed repeatedly without lose of structural integrity and while maintaining a substantially air tight seal while the cover is in place on the threadings of the wall; and
further wherein the lower surface of the base of the first container is in contact with the upper surface of the cover of the second container and the distinct configurations of each allows the containers to be stacked on each other.

12. The system of claim 11, further comprising:
a third container, comprising:
a base plate comprised of a first polymeric material and comprising an upper surface and an opposite lower surface wherein the lower surface is non-planar with a distinct configuration;
a substantial cylindrical wall connected to and extending from the upper surface of the base plate to an upper end with threadings positioned therein, the wall comprised of the first polymeric material;
a cover comprised of a second polymeric material different from the first polymeric material, the cover comprising a circular portion having threadings thereon which match and screw to the threadings on the wall and the cover comprising an upper surface which is non-planar and comprise a distant configuration which is a mirror image of the lower surface of the base plate;
a tissue sample positioned in the container;
wherein the first polymeric material and second polymeric material comprise physical characteristics allowing the container to be frozen and thawed repeatedly without lose of structural integrity and while maintaining a substantially air tight seal while the cover is in place on the threadings of the wall; and
further wherein lower surface of the base of the third container is in contact with the upper surface of the first container allowing all three containers to be stacked.

13. The system of claim 11, further comprising a plurality of containers wherein each container comprises:
a base plate comprised of a first polymeric material and comprising an upper surface and an opposite lower surface wherein the lower surface is non-planar with a distinct configuration;
a substantial cylindrical wall connected to and extending from the upper surface of the base plate to an upper end with threadings positioned therein, the wall comprised of the first polymeric material;
a cover comprised of a second polymeric material different from the first polymeric material, the cover comprising a circular portion having threadings thereon which match and screw to the threadings on the wall and the cover comprising an upper surface which is non-planar and comprise a distant configuration which is a mirror image of the lower surface of the base plate;
a tissue sample positioned in the container;
wherein the first polymeric material and second polymeric material comprise physical characteristics allowing the container to be frozen and thawed repeatedly without lose of structural integrity and while maintaining a substantially air tight seal while the cover is in place on the threadings of the wall; and
further wherein the containers are stacked on each other with the lower surface of the base of a container contacting the upper surface of the cover of another container.

14. The system of claim 13, wherein each container further comprises:
a plurality of projections extending upward along and outward from an inner surface of the wall, the projections defining regions for receiving a sample having an orientation, the projections being shaped and arranged to inhibit a change in the orientation of the sample when stored in the container.

15. The system of claim 14, wherein each of the projections has a cross-section having at least a first side, a second side, and a third side, the first side facing the inner surface of the receptacle, the second and third sides being substantially planar.

16. The system of claim 15, wherein the second side is oriented in a direction substantially perpendicular to the third side.

17. The system of claim 14, wherein each of the projections has a cross-section having a substantially hemispherical shape.

18. The system of claim 14, wherein the projections are formed integrally with the receptacle.

19. The system of claim 14, wherein the projections are removably and replaceably attached to the receptacle.

20. The system of claim 13, wherein each container further comprises:
a marking panel extending from the first end of the base, the marking panel having a substantially smooth surface for receiving identifying indicia.

21. The system of claim 20 wherein each marking panel forms an angle with the top surface of the base, the angle being at least 90 degrees.

22. The system of claim 20 wherein each marking panel is formed integrally with the base.

23. A method of storing tissue, comprising:
placing tissue in a container as claimed in claim 1;
placing a cover on the container wherein the container and cover form a fluid tight seal and further wherein the container and cover are comprised of different polymeric materials;
reducing the temperature of the container, cover and tissue to less than 0° C. wherein the seal is maintained.

24. The method of claim 23, further comprising:
labeling the tissue by connecting labeled indicia to the container.

25. A method of providing access to a tissue sample, comprising the steps of:
storing information in a computer database which information is associated with a label on a container as claimed in claim 1;
receiving a query from a user which identifies a characteristic recorded on the label;
identifying a label with the characteristic;
providing the container to the user which container is labeled with the characteristic.

26. The method of claim 25, where the container is provided by a robot instructed by the computer.
